(19) United States
(12) Patent Application Publication
(10) Pub. No.: US 2026/0367604 A1
(43) Pub. Date: Nov. 19, 2026

(54) CNC TOOL LIFE PREDICTION SYSTEM

(71) Applicant: EDIM CO., LTD, Jeonju-si (KR)

(72) Inventors: Hee Gwan LEE, Jeonju-si (KR); Eun Young HEO, Jeonju-si (KR)

(21) Appl. No.: 19/145,733

(22) PCT Filed: Dec. 17, 2024
(86) PCT No.: PCT/KR2024/020535

§ 371 Date: Jul. 3, 2025

(30) Foreign Application Priority Data
Dec. 28, 2023 (KR) 10-2023-0195161

(51) Int. Cl. G05B 19/4065; G05B 19/414

(52) U.S. Cl. CPC G05B 19/4065; G05B 19/4145; G05B 2219/33099; G05B 2219/37434

(57) ABSTRACT

The present invention relates to a CNC tool life prediction system including: a vibration sensor configured to detect vibration of a tool generated during CNC processing and generate vibration data; a state determination module configured to determine a worn state and a processing state of a tool blade in a specific time zone through the vibration data; a database configured to store a tool life including a normal time when the tool operates normally and a hazardous time when the tool operates abnormally due to wear of the tool; and a life calculation unit configured to recalculate the tool life by comparing a usage time of the tool with the tool life when the state determination module determines that an operation state of the tool is abnormal.

### TECHNICAL FIELD

The present invention relates to a system for predicting a life of a CNC tool, and more specifically, to a CNC tool life prediction system for determining a state of a tool by comparing and analyzing magnitudes of vibrations generated from a spindle and a tool blade based on vibration data generated during processing to predict a time until the tool is damaged.

### BACKGROUND ART

In general, in the case of a milling machine that performs a cutting operation using a tool, the tool is used a predetermined number of times and replaced with a new tool in order to maintain the quality of a workpiece to be constant.

In this case, when cutting processing is continuously performed with the damaged tool without recognizing the damaged tool even though the tool is damaged during the cutting processing, the quality of the workpiece deteriorates, and various problems such as waste of a processing material and damage to a machine tool due to abnormal vibration occur.

In addition, due to such a problem, replacing the cutting tool that has been used a predetermined number of times results in replacement of the cutting tool that enables a normal process, which causes waste of a tool and deterioration in efficiency.

Therefore, in order to solve the problems, conventionally, when an operator generates an abnormal signal in a sensor, the operator directly determines and replaces the tool, but it is difficult for the operator to accurately determine this time point, and one damage detection setting value is set for each process performed using one tool, resulting in false detection in response to an instantaneous change in magnitude unrelated to damage generated during the processing.

In addition, when the operator arbitrarily inputs the damage detection setting value based on reference data, reliability may be low, resulting in problems such as recognizing the tool as being damaged even though the tool is normal or not recognizing the damaged tool even through the tool is damaged. Moreover, since the change in magnitude of a vibration acceleration signal varies depending on processing conditions and environment, repetitive operations in which the operator needs to directly set a reference value of a detection area based on the reference data every time before the process causes deterioration in productivity and accessibility.

Korean Registered Patent No. 10-2580409 relates to a method for detecting wear or damage of a tool in real time by converting a vibration acceleration signal of a rotating tool for cutting operation, in which the vibration acceleration signal of the tool is received to perform a fast Fourier transform and derive a frequency signal, and an abnormality of the tool is determined when a frequency greater than a reference value is detected, but a standard thereof is not clear and is difficult to grasp accurately.

In Japanese Registered Patent No. 5543890, a threshold value is set by adding a preset coefficient to the maximum value of a frequency analysis waveform, and it is determined that an abnormality has occurred during the processing when the frequency analysis waveform generated during the processing is greater than the preset threshold value, but it is difficult to accurately determine a state of the tool simply by using the threshold value.

### DISCLOSURE

### Technical Problem

An object of the present invention is to provide a tool life prediction system capable of efficiently using a tool blade by checking a state of the tool blade by analyzing vibration data generated during processing in a CNC cutting machine and minimizing damage to a workpiece by predicting the life of the tool.

### Technical Solution

The present invention may include: a vibration sensor configured to detect vibration of a tool generated during CNC processing and generate vibration data; a state determination module configured to determine a worn state and a processing state of a tool blade in a specific time zone through the vibration data; a database configured to store a tool life including a normal time when the tool operates normally and a hazardous time when the tool operates abnormally due to wear of the tool; and a life calculation unit configured to recalculate the tool life by comparing a usage time of the tool with the tool life when the state determination module determines that an operation state of the tool is abnormal.

The life calculation unit may reduce the tool life by a time difference between the usage time and the normal time when the usage time is shorter than the normal time at an abnormal time point where an abnormality occurs in the tool.

The life calculation unit may reduce the hazardous time in proportion to the time difference between the usage time and the normal time.

The state determination module may include: a spindle vibration extraction unit configured to extract a spindle vibration value, which is a vibration magnitude of a frequency band corresponding to a spindle, by analyzing the vibration data; a tool blade vibration extraction unit configured to extract a tool blade vibration value, which is a vibration magnitude of a frequency band corresponding to a tool blade, by analyzing the vibration data; an other frequency vibration extraction unit configured to extract an other frequency vibration value, which is a vibration magnitude of a frequency band except for the frequency bands corresponding to the spindle and the tool blade, from the vibration data; a database configured to store the tool blade vibration value, which is generated when the tool blade is normal, as a vibration reference value; and a tool state determination unit configured to determine a state of the tool blade by analyzing the spindle vibration value, the tool blade vibration value, the other frequency vibration value, and the vibration reference value.

A vibration magnitude that allows the tool state determination unit to determine that the tool is normally operated because the tool blade and the processing state are normal may be calculated based on following [Equation 1]:

Other frequency vibration value<Spindle vibration value<Tool blade vibration value=Vibration reference value z [Equation 1]
(wherein, vibration reference value z: error range of vibration reference value at 95% confidence level).

A vibration magnitude that allows the tool state determination unit to determine that the tool is normally operated because a part of the tool blade is worn and the processing state is normal may be calculated based on following [Equation 2]:

Other frequency vibration value<Spindle vibration value<Vibration reference value<Tool blade vibration value. [Equation 2]

A vibration magnitude that allows the tool state determination unit to determine that the tool is abnormally operated because the tool blade is worn and the processing state is intermittently defective may be calculated based on following [Equation 3]:

(Vibration reference value<Other frequency vibration value) AND (Tool blade vibration value<Other frequency vibration value). [Equation 3]

A vibration magnitude that allows the tool state determination unit to determine that the tool is abnormally operated because the tool blade is worn and the processing state is defective may be calculated based on following [Equation 4] and [Equation 5]:

Tool blade vibration value≤Spindle vibration value [Equation 5]

dev Vibration reference value<dev(A) Tool blade vibration value<dev(B) Tool blade vibration value
(wherein, dev vibration reference value: tool blade frequency band vibration magnitude fluctuation range calculated when tool blade is normal and processing is normal, dev(A) tool blade vibration value: tool blade frequency band vibration magnitude fluctuation range calculated when part of tool blade is worn and processing is normal, dev(B) tool blade vibration value: current tool blade frequency band vibration magnitude fluctuation range).

A vibration magnitude that allows the tool state determination unit that the tool blade is damaged may be calculated based on following [Equation 6] and [Equation 7]:

(Other frequency vibration value AND Tool blade vibration value)≤Spindle vibration value [Equation 6]

Det_n=Round (Tol/f_z), Consecutive number of times of tool damage diagnosis exceeds Det_n [Equation 7]
(wherein, Det_n: number of times of detecting tool abnormality, Tol: Allowable tolerance, f_z: Transport quantity per tool blade, Round: rounded integer).

### Advantageous Effects

According to the present invention, it is possible to accurately grasp the state of the tool blade by comparing and analyzing a magnitude of vibration for each frequency generated during processing

### DESCRIPTION OF DRAWINGS

FIG. 1 is a block diagram of a system of diagnosing and predicting a state of a CNC processing tool according to an embodiment of the present invention.

FIG. 2 is a diagram showing a method for predicting a life of a tool blade of an area setting unit according to the embodiment of the present invention.

FIG. 3 is a diagram showing vibration data in which the tool blade is normal according to the embodiment of the present invention.

FIG. 4 is a diagram showing vibration data generated by an abnormal tool blade according to the embodiment of the present invention.

FIG. 5 is a flowchart of the system of diagnosing and predicting a state of a CNC processing tool according to the embodiment of the present invention.

100: Vibration sensor 200: Spindle vibration extraction unit
300: Tool blade vibration extraction unit 400: Other frequency vibration extraction unit
500: Database 600: Tool state determination unit
700: Life calculation unit
S10: Vibration data generation step S20: Spindle vibration extraction step
S30: Tool blade vibration extraction step S40: Other frequency vibration extraction step
S50: Vibration reference storage step S60: Tool state determination step

### BEST MODE FOR INVENTION

Hereinafter, preferred embodiments according to the present invention will be described in detail with reference to the accompanying drawings.

The advantages and features of the present invention and a method of achieving the advantages and features will become more apparent from the embodiments described in detail in conjunction with the accompanying drawings.

However, the present invention is not limited by the embodiments disclosed below, but will be implemented in various forms. In addition, the present embodiments are merely intended to complete the disclosure of the present invention, and provided to fully inform the scope of the present invention to those skilled in the art to which the present invention pertains.

In addition, when it is determined that there is a known technology and the like in regards to describing the present invention which may blur the point of the present invention, detailed description thereof will be omitted.

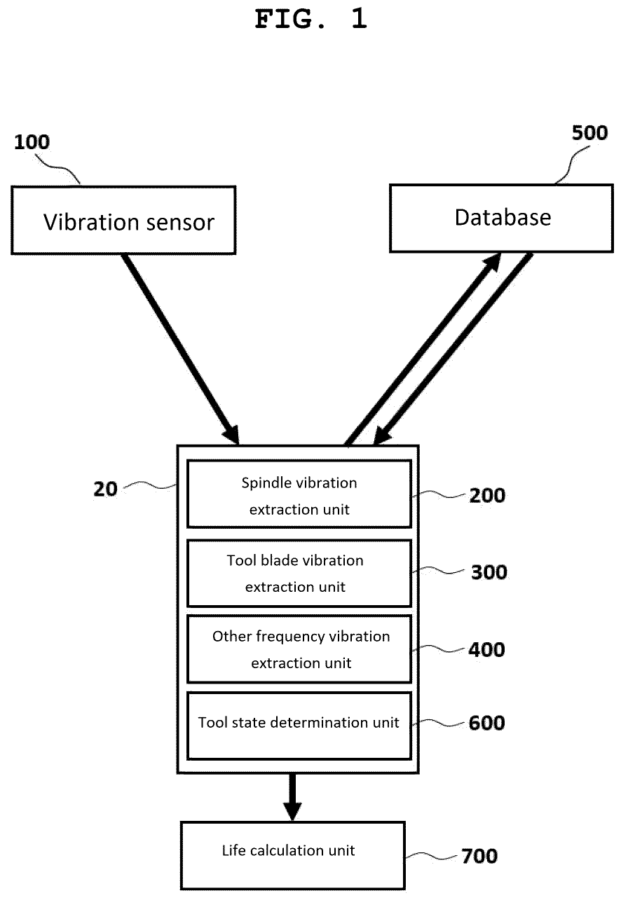

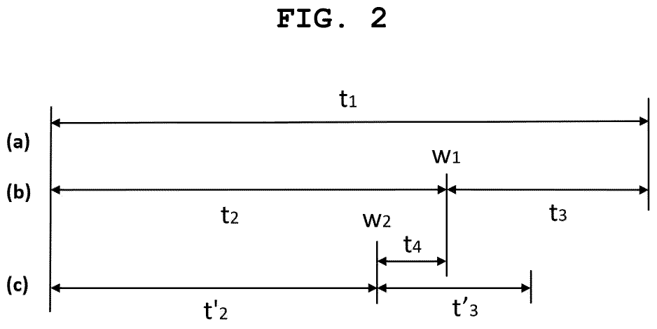

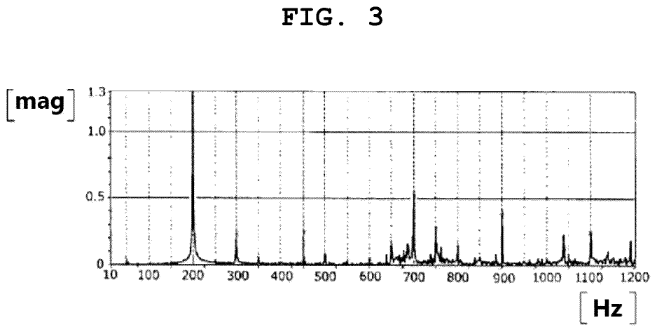

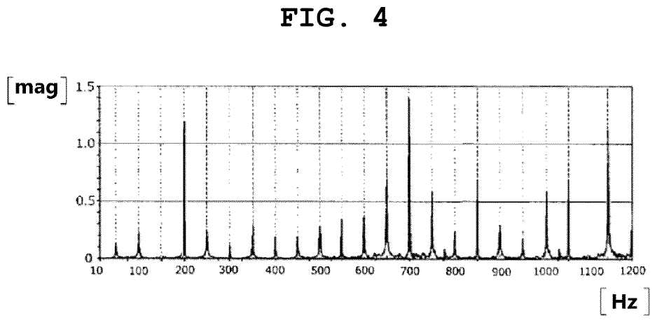

FIG. 1 is a block diagram of a system of diagnosing and predicting a state of a CNC processing tool according to an embodiment of the present invention, FIG. 2 is a diagram showing a method for predicting a life of a tool blade of an area setting unit according to the embodiment of the present invention, FIG. 3 is a diagram showing vibration data in which the tool blade is normal according to the embodiment of the present invention, and FIG. 4 is a diagram showing vibration data generated by an abnormal tool blade according to the embodiment of the present invention.

As shown in FIG. 1, the system may include a vibration sensor 100, a state determination module 20, a database 500, and a life calculation unit 700.

The vibration sensor 100 may be installed in a CNC processing apparatus to detect vibration generated during a cutting operation, thereby generating vibration data.

The vibration data may be a graph indicating a magnitude of vibration detected at each frequency.

The database 500 may store a tool life t1 calculated by predicting a life of the tool blade through the state determination module 20.

Specifically, an average of a time until a plurality of tool blades used for the cutting processing are replaced and damaged may be set as the tool life.

The tool life t1 may vary depending on the size, shape, material, and the like of the tool blade.

As shown in FIG. 2, the life calculation unit 700 may set a normal time t2, a hazardous time t3, and a hazardous time point w1 in the tool life t1.

In FIG. 2, (a) may show the tool life of a general tool blade, (b) may show the normal time, hazardous time, and wear time point of the general tool blade, and (c) may show the tool life, normal area, and hazardous area of a defective tool blade.

The normal time t2 may be a time when the tool is normally operated because the worn state and the processing state of a workpiece are normal.

Specifically, as shown in FIG. 2, a time when the tool blade is not severely worn and a defect does not occur in the cutting processing of the workpiece in the tool life t1 of the tool blade may be extracted from a plurality of tool lifes to set an average time as the normal time t2.

The hazardous time t3 may be a time when the tool is abnormally operated because the worn state of the tool blade and the processing state of the workpiece are defective.

Specifically, as shown in FIG. 2, a time from the time when the tool is abnormally operated to a time when the tool is damaged may be set as the hazardous time t3.

In this case, at the hazardous time t3, the tool blade is severely worn, and the defect of the workpiece increases during the cutting processing, so that the probability of damage to the tool blade may be increased.

The hazardous time point w1 may be set as a boundary point between the normal time t2 and the danger time t3 in the tool life.

When a usage time of the tool at an abnormal time point w2 where the abnormality occurs in the tool is shorter than the normal time t2, the life calculation unit 700 may reduce the tool life t1 by a time difference between the usage time of the abnormal time point w2 and the normal time t2.

Specifically, when the defective tool blade is used for the cutting operation rather than the general tool blade, a special normal time t′2 of the defective tool blade is shorter than the general normal time t2 of the general tool blade, and a time point where the abnormality occurs in the defective tool blade may be set as the abnormal time point w2.

Accordingly, a correction time t4, which is an interval between the general normal time t2 and a special normal area t′2 (t2>t′2), that is, a time from the hazardous time point w1 to the abnormal time point w2, may be calculated.

The life calculation unit 700 may calculate a proportion of the correction time t4 in the general normal time t2 and may reduce the proportion by applying the same to the hazardous time t3 (t3>t′3).

Specifically, the defective tool blade has a tool life shorter than the predicted tool life t1, and in order to predict the reduced tool lifes t′2 and t′3, the proportion of the correction time t4 may be applied to the hazardous time t3, thereby reducing the tool life t1.

For example, when the tool life t1 is 100 hours, the normal time t2 is 80 hours, and the hazardous time t3 is 20 hours, in a case where the abnormal time point w2 occurs at 60 hours due to the tool defect, the tool life may be reset to 80 hours by excluding 20 hours, which is a time difference between the normal time t2 and the time when the abnormal time point w2 occurs, from the tool life t1.

In addition, the tool life may be reset to 75 hours by applying 25%, which is a proportion of 20 hours that is the time difference between the normal time t2 and the time when the abnormal time point w2 occurs, in the normal time t2, to the hazardous time t3, and predicting the hazardous time t′3 due to the tool defect to be 15 hours.

In this case, when the time that may be normally used is reduced due to the tool defect, a time until the tool is damaged is also reduced, and thus both the normal time t2 and the hazardous time t3 are reduced, thereby accurately predicting the life of the tool.

Therefore, it is possible to accurately predict the life of the tool blade by predicting changes in the normal time t2, the hazardous time t3, and the abnormal time point w2 according to the defective state of the tool blade.

When the tool blade is included in the hazardous time t3, it is possible to guide a user to replace the tool blade.

The state determination module 20 may include a spindle vibration extraction unit 200, a tool blade vibration extraction unit 300, an other frequency vibration extraction unit 400, and a tool state determination unit 600.

The spindle vibration extraction unit 200 may extract a vibration magnitude of a frequency band corresponding to a spindle from the vibration data generated through the vibration sensor 100.

Specifically, a frequency of the vibration generated in the spindle during the processing appears in a specific frequency, that is, a spindle frequency band, so that the spindle vibration extraction unit 200 may extract a spindle vibration value, which is a vibration magnitude corresponding to the spindle frequency band, from the vibration data.

The tool blade vibration extraction unit 300 may extract a vibration magnitude of a frequency band corresponding to the tool blade from the vibration data generated through the vibration sensor 100.

Specifically, a frequency of the vibration generated in the tool blade during the processing appears in a tool blade frequency band, which is a specific frequency, so that the tool blade vibration extraction unit 300 may extract a tool blade vibration value, which is a vibration magnitude corresponding to the tool blade frequency band, from the vibration data.

In addition, since the tool blade frequency band is changed according to the number of tool blades, the tool blade vibration extraction unit 300 may set the tool blade frequency band by receiving the number of tool blades in advance.

The other frequency vibration extraction unit 400 may extract a vibration magnitude of a frequency band except for the spindle frequency band and the tool blade frequency band.

That is, the other frequency vibration extraction unit 400 may detect the magnitude of vibration generated when the tool processes the workpiece due to factors other than cutting by rotation of the tool blade because the frequency of a plurality of components such as CNC tool equipment cases and the wear of the tool blade are increased.

When cutting is not performed by rotating the tool blade, the vibration magnitude related to a chatter phenomenon, which is the phenomenon in which the tool body or the tool blade vibrates by receiving a large external force, may be detected.

The database 500 may store the tool blade vibration value generated when the tool blade is normal as a vibration reference value.

Specifically, in a method for setting a reference value to determine an abnormal state of the tool blade from the vibration data that is detected through the detection sensor, the workpiece may be processed through the tool blade in a normal state, and the vibration data detected when high-quality processing is performed may be set as a vibration reference value.

The tool state determination unit 600 may determine a state of the tool blade by comparing and analyzing the spindle vibration value, the tool blade vibration value, the other frequency vibration value, and the vibration reference value.

Specifically, the state of the tool blade may be determined by checking which the vibration value is larger among the spindle vibration value, the tool blade vibration value, the other frequency vibration value, and the vibration reference value.

When the following [Equation 1] is satisfied, the tool state determination unit 600 may determine that the state of the tool blade is normal and the high-quality processing is performed:

Other frequency vibration value<Spindle vibration value<Tool blade vibration value=Vibration reference value z [Equation 1]
wherein the vibration reference value z is in an error range occurring at 95% confidence level in the vibration reference value.

That is, as shown in FIG. 3, referring to the vibration data detected under the CNC process condition according to the embodiment of the present invention, a frequency generated when the tool blade cuts the workpiece (material or product) is 200 Hz, and the largest vibration magnitude may occur in the corresponding frequency band.

In this case, since the cutting processing is performed using only the tool blade when the workpiece is cut in a state where the tool blade is normal, the tool blade has the largest vibration magnitude in the frequency band corresponding to the vibration generated in the tool blade.

Therefore, since only the tool blade is involved in the cutting processing, a load on the spindle is not increased, and a CNC processing machine generates only general vibration, so that the tool blade may have a vibration magnitude lower than the tool blade vibration value.

In addition, the other frequency vibration value may be less than the spindle vibration value generated in the spindle.

In addition, in order to determine the normal state of the tool blade, similarity between the tool blade vibration value and the vibration reference value of the current cutting processing may be determined.

When the tool blade vibration value is different from the vibration reference value by a preset value or greater, it may be determined that there is a change in the tool blade.

When the following [Equation 2] is satisfied, the tool state determination unit 600 may determine that a part of the tool blade is worn but the high-quality processing is performed.

Other frequency vibration value<Spindle vibration value<Vibration reference value<Tool blade vibration value. [Equation 2]

Specifically, referring to the vibration data under the CNC process condition, although the tool blade is worn compared to the normal state, the frequency generated when the workpiece is cut may maintain 200 Hz, and the largest vibration magnitude in the corresponding frequency band may occur.

In addition, the vibration magnitude when the tool blade is a worn state is increased compared to when the tool blade is normal, so that the tool blade vibration value may have a value greater than the vibration reference value.

When the following [Equation 3] is satisfied, the tool state determination unit 600 may determine that the tool blade is worn and the processing state is intermittently defective.

(Vibration reference value<Other frequency vibration value) OR (Tool blade vibration value<Other frequency vibration value). [Equation 3]

In this state, a case where the tool blade vibration value of the tool blade performing cutting is large due to considerable wear of the tool blade and a case where the largest value of the other frequency vibration value occurs due to abnormal cutting may occur in a mixed manner.

Specifically, as shown in FIG. 3, to the vibration data under the CNC processing condition, wear of the tool blade may be increased, and thus, a case where the tool processes the workpiece due to a factor other than cutting by rotation of the tool blade may occur.

For example, the vibration magnitude of the other frequency band may increase due to a chatter, which is the phenomenon in which the tool body or the tool blade vibrates by receiving a large external force.

Therefore, as shown in FIG. 4, it may be determined that the other frequency vibration value is large at 700 hz compared to the vibration reference value and the tool blade vibration value, which are the vibration magnitudes of the frequencies corresponding to the tool blade, and the tool blade is significantly worn.

When the corresponding Equation is satisfied, it may be determined that the tool has been used for the hazardous time t3, and it may be determined as a step that still requires the operator's attention at a warning level.

When the following [Equation 4] and [Equation 5] are satisfied, the tool state determination unit 600 may determine that the tool blade is partially damaged and the processing state is significantly defective:

Tool blade vibration value>Spindle vibration value [Equation 4]

dev Vibration reference value<dev(A) Tool blade vibration value<dev(B) Tool blade vibration value [Equation 5]
wherein, the dev vibration reference value may represent a fluctuation range in which the vibration reference value is changed in a normal state when the tool blade is normal and the high-quality processing is performed.

The dev(A) tool blade vibration value may represent a fluctuation range in which the tool blade vibration value is changed when a part of the tool blade is worn and the processing is normal.

The dev(B) tool blade vibration value may represent a fluctuation range in which the tool blade vibration value is changed when the tool blade is severely worn and the processing is abnormal.

Specifically, when the processing is continuously performed in a state where the tool blade is severely worn, a case where the spindle vibration value is greater than the tool blade vibration value and a case where the tool blade vibration value is largest may occur in a mixed manner.

For example, when the tool blade is partially damaged, that is, when one of the two tool blades is broken and the other thereof is in a normal tool state, the frequency band of the tool blade and the frequency band of the spindle are the same, so that the spindle vibration value corresponding to the spindle frequency band may have the largest value.

Alternatively, even if both tool blades undergo the cutting processing due to serious damage to the size and shape of the tool blades when the tool blades are severely worn, the vibration magnitude of the tool blade vibration value may fluctuate very significantly.

Therefore, the fluctuation range of the tool blade vibration value when the worn state is serious may be larger than the fluctuation range of the tool blade vibration value when the tool blade is normal or less worn.

When the corresponding Equations are satisfied, it may be determined as a step in which the tool has been used for the hazardous time t3 and an operator needs to quickly replace perform the tool replacement at a hazardous level at which the tool may be damaged at any time.

When the following [Equation 6] and [Equation 7] are satisfied, the tool state determination unit 600 may determine that the tool blade is fully damaged:

(Other frequency vibration value AND Tool blade vibration value)≤Spindle vibration value [Equation 6]

Det_n=Round (Tol/f_z), Consecutive number of times of tool damage diagnosis exceeds Det_n [Equation 7]
wherein Det_n may be the number of times of detecting tool abnormality, Tol may be an allowable tolerance, f_z may be a transport quantity per tool blade, and Round may be a rounded integer.

Specifically, it may be determined that the tool is defective when the tool is out of an allowable tolerance range of the product due to continuous abnormal cutting of the tool in consideration of the transport quantity per tool blade.

For example, when the allowable tolerance Tol of the workpiece is ±0.1, the spindle RPM (revolutions per minute) is 6000 RPM, and the transport quantity f_z per tool blade is 0.05, it may be determined that the tool is defective when the number of times of processing of the abnormal tool blade is continuously detected two or more times.

In addition, when the tool is damaged, cutting of the workpiece is not performed, so that the tool blade vibration value and the other frequency vibration value may be equal to or less than the spindle vibration value.

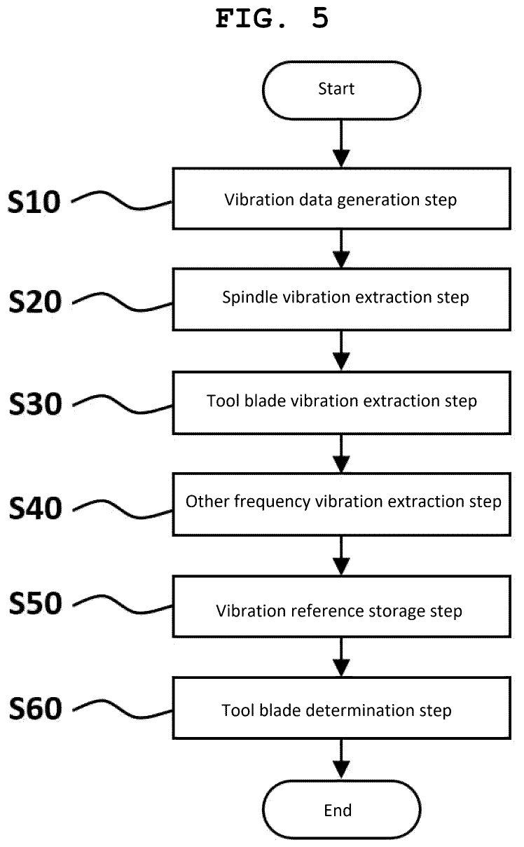

FIG. 5 is a flowchart of the system of diagnosing and predicting a state of a CNC processing tool according to the embodiment of the present invention.

As illustrated in FIG. 5, the order of the method for diagnosing a state of the CNC processing tool may include a vibration data generation step S10, a spindle vibration extraction step S20, a tool blade vibration extraction step S30, an other frequency vibration extraction step S40, a vibration reference storage step S50, and a tool state determination step S60.

In the vibration data generation step S10, vibration data may be generated by detecting vibration of the tool generated during CNC processing using the vibration sensor 100.

The vibration data may be a graph indicating a magnitude of vibration detected at each frequency.

In the spindle vibration extraction step S20, a spindle vibration value, which is a vibration magnitude of a frequency band corresponding to the spindle, may be extracted by analyzing the vibration data.

Specifically, a frequency of the vibration generated in the spindle during the processing appears in a specific frequency, that is, a spindle frequency band, so that in the spindle vibration extraction step S20, a spindle vibration value, which is a vibration magnitude corresponding to the spindle frequency band, may be extracted from the vibration data.

In the tool blade vibration extraction step S30, a tool blade vibration value, which is a vibration magnitude of a frequency band corresponding to the tool blade, may be extracted by analyzing the vibration data.

Specifically, a frequency of the vibration generated in the tool blade during the processing appears in a tool blade frequency band, which is a specific frequency, so that in the tool blade vibration extraction step S30, a tool blade vibration value, which is a vibration magnitude corresponding to the tool blade frequency band, may be extracted from the vibration data.

In the other frequency vibration extraction step S40, the other frequency vibration value, which is a frequency magnitude of the frequency band except for the frequency bands corresponding to the spindle and the tool blade, may be extracted from the vibration data.

That is, in the other frequency vibration extraction step S40, the magnitude of vibration generated when the tool processes the workpiece due to factors other than cutting by rotation of the tool blade may be detected because the frequency of a plurality of components such as CNC tool equipment cases and the wear of the tool blade are increased.

When cutting is not performed by rotating the tool blade, the vibration magnitude related to a chatter phenomenon, which is the phenomenon in which the tool body or the tool blade vibrates by receiving a large external force, may be detected.

In the vibration reference storage step S50, the tool blade vibration value generated when the tool blade is normal may be stored as a vibration reference value.

Specifically, a workpiece may be processed through the tool blade in a normal state using a method for setting a reference value to determine an abnormal state of the tool blade from the vibration data that is detected through the detection sensor, and the vibration data detected when high-quality processing is performed may be set as a vibration reference value.

In the tool state determination step S60, a state of the tool blade may be determined by comparing and analyzing the spindle vibration value, the tool blade vibration value, the other frequency vibration value, and the vibration reference value.

Specifically, the state of the tool blade may be determined by checking which the vibration value is larger among the spindle vibration value, the tool blade vibration value, the other frequency vibration value, and the vibration reference value.

In the tool state determining step S60, when the spindle vibration value is greater than the other frequency vibration value and the tool blade vibration value is greater than the spindle vibration value, it may be determined that the cutting processing is performed.

In addition, when the tool blade vibration value is in an error range occurring at a 95% confidence level from the vibration reference value, it may be determined that the state of the tool blade is normal and the high-quality processing is performed.

In this case, since the cutting processing is performed using only the tool blade when the workpiece is cut in a state where the tool blade is normal, the tool blade may have the largest vibration magnitude in the frequency band corresponding to the vibration generated in the tool blade.

Therefore, since only the tool blade is involved in the cutting processing, a load on the spindle is not increased, and a CNC processing machine generates only general vibration, so that the tool blade may have a vibration magnitude lower than the tool blade vibration value.

In the tool state determining step S60, when the spindle vibration value is greater than the other frequency vibration value, the tool blade vibration value is greater than the spindle vibration value, and the tool blade vibration value is greater than the vibration reference value, it may be determined that the wear of the tool blade is performed.

In this case, the vibration magnitude when the tool blade is a worn state is increased compared to when the tool blade is normal, so that the tool blade vibration value may have a value greater than the vibration reference value.

In the tool state determining step S60, when the other frequency vibration value is greater than the vibration reference value and the tool blade vibration value, it may be determined that the tool blade is worn and the processing state is intermittently defective.

In this case, a case where the tool blade vibration value of the tool blade performing normal cutting is large due to considerable wear of the tool blade and a case where the largest value of the other frequency vibration value occurs due to abnormal cutting may occur in a mixed manner.

Therefore, when the other frequency vibration value is greater than the vibration reference value and the tool blade vibration value of the tool blade when the tool blade is normal and partially worn.

In the tool state determination step S60, when the spindle vibration value is greater than the tool blade vibration value and the detected tool blade vibration value is large compared to the fluctuation range of the vibration reference value and the fluctuation range of the tool blade vibration value when the tool blade is partially worn, it may be determined that the tool blade is worn and the processing state is defective.

In this case, when the processing is continuously performed in a state where the tool blade is severely worn, a case where the spindle vibration value is greater than the tool blade vibration value and a case where the tool blade vibration value is largest may occur in a mixed manner.

Therefore, even if the tool blade undergoes the cutting processing due to serious damage to the size and shape of the tool blade when the tool blade is severely worn, since the fluctuation of vibration magnitude of the tool blade vibration value is very large, the fluctuation range of the tool blade vibration value when the worn state is serious may be larger than the fluctuation range of the tool blade vibration value when the tool blade is normal or less worn.

In the tool state determining step (S60), it may be determined that the tool is defective when the spindle vibration value is greater than the other frequency vibration value and the tool blade vibration value, the abnormal cutting of the tool continuously occurs in consideration of the transport quantity per tool blade, and the tool is out of the allowable tolerance range of the product.

For example, when the allowable tolerance Tol of the workpiece is ±0.1, the spindle RPM (revolutions per minute) is 6000 RPM, and the transport quantity f_z per tool blade is 0.05, it may be determined that the tool is defective when the number of times of processing of the abnormal tool blade is continuously detected two or more times.

While the above-described disclosure has been described with reference to the embodiment(s) shown in the drawings, it will be to be understood that various changes and modifications may be made without departing from the scope of the present invention, and it will be appreciated that all or some of the embodiment(s) described above may be optionally constructed in combination. Therefore, the true technical scope to be protected by the present invention should be determined by the technical idea of the appended claims.

### INDUSTRIAL APPLICABILITY

The present invention relates to a system for predicting the life of a CNC tool, and more specifically, the system may compare and analyze magnitudes of vibrations generated from a spindle and a tool blade based on vibration data generated during processing to predict a time until the tool is damaged, so that the present invention may be very useful in the t industry.

1. A CNC tool life prediction system comprising:
a vibration sensor configured to detect vibration of a tool generated during a CNC process and generate vibration data;
a state determination module configured to determine a worn state and a processing state of a tool blade in a specific time zone through the vibration data;
a database configured to store a tool life including a normal time when the tool operates normally and a hazardous time when the tool operates abnormally due to wear of the tool; and
a life calculation unit configured to recalculate the tool life by comparing a usage time of the tool with the tool life when the state determination module determines that an operation state of the tool is abnormal.

2. The CNC tool life prediction system of claim 1, wherein the life calculation unit reduces the tool life by a time difference between the usage time and the normal time when the usage time is shorter than the normal time at an abnormal time point where an abnormality occurs in the tool.

3. The CNC tool life prediction system of claim 2, wherein the life calculation unit reduces the hazardous time in proportion to the time difference between the usage time and the normal time.

4. The CNC tool life prediction system of claim 1, wherein the state determination module includes:
a spindle vibration extraction unit configured to extract a spindle vibration value, which is a vibration magnitude of a frequency band corresponding to a spindle, by analyzing the vibration data;
a tool blade vibration extraction unit configured to extract a tool blade vibration value, which is a vibration magnitude of a frequency band corresponding to a tool blade, by analyzing the vibration data;
an other frequency vibration extraction unit configured to extract an other frequency vibration value, which is a vibration magnitude of a frequency band except for the frequency bands corresponding to the spindle and the tool blade, from the vibration data;
a database configured to store the tool blade vibration value, which is generated when the tool blade is normal, as a vibration reference value; and
a tool state determination unit configured to determine a state of the tool blade by analyzing the spindle vibration value, the tool blade vibration value, the other frequency vibration value, and the vibration reference value.

5. The CNC tool life prediction system of claim 4, wherein a vibration magnitude that allows the tool state determination unit to determine that the tool is normally operated because the tool blade and the processing state are normal is calculated based on following [Equation 1]:
Other frequency vibration value<Spindle vibration value<Tool blade vibration value=Vibration reference value z [Equation 5]
(wherein, vibration reference value z: error range of vibration reference value at 95% confidence level).

6. The CNC tool life prediction system of claim 4, wherein a vibration magnitude that allows the tool state determination unit to determine that the tool is normally operated because a part of the tool blade is worn and the processing state is normal is calculated based on following [Equation 2]:
Other frequency vibration value<Spindle vibration value<Vibration reference value<Tool blade vibration value. [Equation 2]

7. The CNC tool life prediction system of claim 4, wherein a vibration magnitude that allows the tool state determination unit to determine that the tool is abnormally operated because the tool blade is and the processing state is intermittently defective is calculated based on following [Equation 3]:
(Vibration reference value<Other frequency vibration value) OR (Tool blade vibration value<Other frequency vibration value). [Equation 3]

8. The CNC tool life prediction system of claim 4, wherein a vibration magnitude that allows the tool state determination unit to determine that the tool is abnormally operated because the tool blade is worn and the processing state is defective is calculated based on following [Equation 4] and [Equation 5]:
Tool blade vibration value>Spindle vibration value [Equation 4]
dev Vibration reference value<dev(A) Tool blade vibration value<dev(B) Tool blade vibration value [Equation 5]
(wherein, dev vibration reference value: tool blade frequency band vibration magnitude fluctuation range calculated when tool blade is normal and processing is normal, dev(A) tool blade vibration value: tool blade frequency band vibration magnitude fluctuation range calculated when part of tool blade is worn and processing is normal, dev(B) tool blade vibration value: current tool blade frequency band vibration magnitude fluctuation range).

9. The CNC tool life prediction system of claim 4, wherein a vibration magnitude that allows the tool state determination unit that the tool blade is damaged is calculated based on following [Equation 6] and [Equation 7]:
(Other frequency vibration value AND Tool blade vibration value)≤Spindle vibration value [Equation 6]
Det_n=Round (Tol/f_z), Consecutive number of times of tool damage diagnosis exceeds Det_n [Equation 7]
(wherein, Det_n: number of times of detecting tool abnormality, Tol: Allowable tolerance, f_z: Transport quantity per tool blade, Round: rounded integer).
